(19) United States
(12) Patent Application Publication
(10) Pub. No.: US 2026/0230187 A1
(43) Pub. Date: Aug. 6, 2026

(54) COMMUNICATION DEVICE, OPTICAL ADD/DROP APPARATUS, AND SIGNAL PROCESSING METHOD

(71) Applicant: NTT, Inc., Tokyo (JP)

(72) Inventors: Junichi KANI, Musashino-shi (JP); Shin KANEKO, Musashino-shi (JP); Osamu MORIWAKI, Musashino-shi (JP); Kenya SUZUKI, Musashino-shi (JP)

(73) Assignee: NTT, Inc., Tokyo (JP)

(21) Appl. No.: 19/152,369

(22) PCT Filed: Feb. 3, 2023
(86) PCT No.: PCT/JP2023/003647

§ 371 Date: Jul. 30, 2025

(51) Int. Cl. H04B 10/40

(52) U.S. Cl. CPC H04B 10/40

(57) ABSTRACT

An aspect of the present invention is a communication device including downlink distribution units that receive signals from one or more paths, the downlink distribution units being provided as many as the number of the paths, downlink coupling units that receive signals from the respective downlink distribution units and output signals to optical signal transceivers, the downlink coupling units being provided as many as the maximum number of the optical signal transceivers, and a simultaneous distribution unit that is provided between the downlink coupling units and the optical signal transceivers and is capable of simultaneously outputting signals having wavelengths input from a plurality of paths input from the downlink coupling units to the plurality of optical signal transceivers.

### TECHNICAL FIELD

The present invention relates to a technology of a communication device, an optical add/drop apparatus, and a signal processing method.

### BACKGROUND ART

A reconfigurable optical add/drop multiplexer (ROADM) forming an optical wavelength multiplexing network includes an optical cross-connect unit, an optical add/drop unit, and an optical transceiver as illustrated in FIG. 9.

The optical add/drop unit includes the same number of distribution units and coupling units as the maximum number of paths (n: n=4 in the drawing) of the optical cross-connect unit that transmits and receives signals to and from an adjacent network node. The optical add/drop unit includes the same number of downlink switch units and uplink switch units as the maximum number of optical transceivers (m: m=4 in the drawing).

The distribution unit and the coupling unit can be formed of an optical splitter, an optical coupler, and a wavelength selective switch (WSS). The downlink switch unit and the uplink switch unit are optical path selective switches.

In the technology disclosed in Non Patent Literature 1, a circuit equivalent to the distribution unit (1×n optical splitter)+downlink switch unit, and the uplink switch unit+coupling unit (n×1 optical coupler) is implemented by using a circuit obtained by connecting 1×2 optical switches and gate switches in a matrix. In the technology disclosed in Non Patent Literature 2, the distribution unit and the coupling unit are implemented by the WSS.

With such a configuration of the optical add/drop unit, each optical transceiver can transmit/receive an optical signal to/from any path of the optical cross-connect unit by any wavelength pair (a pair of an uplink wavelength and a downlink wavelength).

### CITATION LIST

### Non Patent Literature

Non Patent Literature 1: T. Watanabe, K. Suzuki, and T. Takahashi, “Multicast Switch Technology that Enhances ROADM Operability,” NTT Technical Review, Vol. 12, No. 1, pp. 1-5, 2014.

Non Patent Literature 2: P. D. Colbourne, S. Mclaughlin, C. Murley, S. Gaudet and D. Burke, “Contentionless Twin 8×24 WSS with Low Insertion Loss,” 2018 Optical Fiber Communications Conference and Exposition (OFC), 2018, pp. 1-3.

### SUMMARY OF INVENTION

### Technical Problem

In the conventional technology described above, there has been a problem that the number of optical fibers required in a case where a plurality of optical transceivers is extended to different places increases in proportion to the number of optical transceivers.

In view of the above circumstances, an object of the present invention is to provide a technology capable of reducing the number of optical fibers required in a case where a plurality of optical transceivers is extended to different places as compared with the conventional technology.

### Solution to Problem

An aspect of the present invention is a communication device including downlink distribution units that receive signals from one or more paths, the downlink distribution units being provided as many as the number of the paths, downlink coupling units that receive signals from the respective downlink distribution units and output signals to optical signal transceivers, the downlink coupling units being provided as many as the maximum number of the optical signal transceivers, and a simultaneous distribution unit that is provided between the downlink coupling units and the optical signal transceivers and is capable of simultaneously outputting signals having wavelengths input from a plurality of paths input from the downlink coupling units to the plurality of optical signal transceivers.

An aspect of the present invention is a communication device including uplink coupling units that output signals to one or more paths, the uplink coupling units being provided as many as the paths, uplink distribution units that output signals to the respective uplink coupling units, the uplink distribution units being provided as many as the maximum number of the optical signal transceivers, and a simultaneous coupling unit that receives signals from the plurality of optical signal transceivers and is capable of simultaneously outputting the input signals to the uplink distribution units.

An aspect of the present invention is an optical add/drop apparatus including downlink distribution units that receive signals from one or more paths, the downlink distribution units being provided as many as the paths, and downlink coupling units that receive signals from the respective downlink distribution units and output signals to optical signal transceivers, the downlink coupling units being provided as many as the maximum number of the optical signal transceivers, in which the downlink coupling units are capable of optionally selecting signals input from a plurality of ports, coupling, and outputting.

An aspect of the present invention is an optical add/drop apparatus including uplink coupling units that output signals to one or more paths, the uplink coupling units being provided as many as the paths, and uplink distribution units that output signals to the respective uplink coupling units, the uplink distribution units being provided as many as the maximum number of the optical signal transceivers, in which the uplink distribution units are capable of distributing signals input from one port to any output destinations.

An aspect of the present invention is a signal processing method including, in an optical add/drop apparatus including downlink distribution units that receive signals from one or more paths, the downlink distribution units being provided as many as the paths, and downlink coupling units that receive signals from the respective downlink distribution units and output signals to optical signal transceivers, the downlink coupling units being provided as many as the maximum number of the optical signal transceivers, optionally selecting signals input from a plurality of ports, coupling, and outputting by the downlink coupling units.

An aspect of the present invention is a signal processing method including, in an optical add/drop apparatus including uplink coupling units that output signals to one or more paths, the uplink coupling units being provided as many as the paths, and uplink distribution units that output signals to the respective uplink coupling units, the uplink distribution units being provided as many as the maximum number of the optical signal transceivers, distributing signals input from one port to any output destinations by the uplink distribution units.

### Advantageous Effects of Invention

The present invention can provide a technology of reducing the number of optical fibers required in a case of where a plurality of optical transceivers is extended to different places as compared with the conventional technology.

### BRIEF DESCRIPTION OF DRAWINGS

FIG. 1 is a block diagram illustrating a configuration of a communication system including a communication device in a first embodiment.

FIG. 2 is a diagram illustrating a configuration example of a selective coupling unit.

FIG. 3 is a diagram illustrating a configuration example of a selective distribution unit.

FIG. 4 is a block diagram illustrating a configuration of a communication system including a communication device in a second embodiment.

FIG. 5 is a block diagram illustrating a configuration of a communication system including a communication device in a third embodiment.

FIG. 6 is a diagram illustrating an application example of the second and third embodiments.

FIG. 7 is a block diagram illustrating a configuration of a communication system including a communication device in a fourth embodiment.

FIG. 8 is a diagram illustrating an application example of the fourth embodiment.

FIG. 9 is a diagram for explaining a conventional example.

### DESCRIPTION OF EMBODIMENTS

### First Embodiment

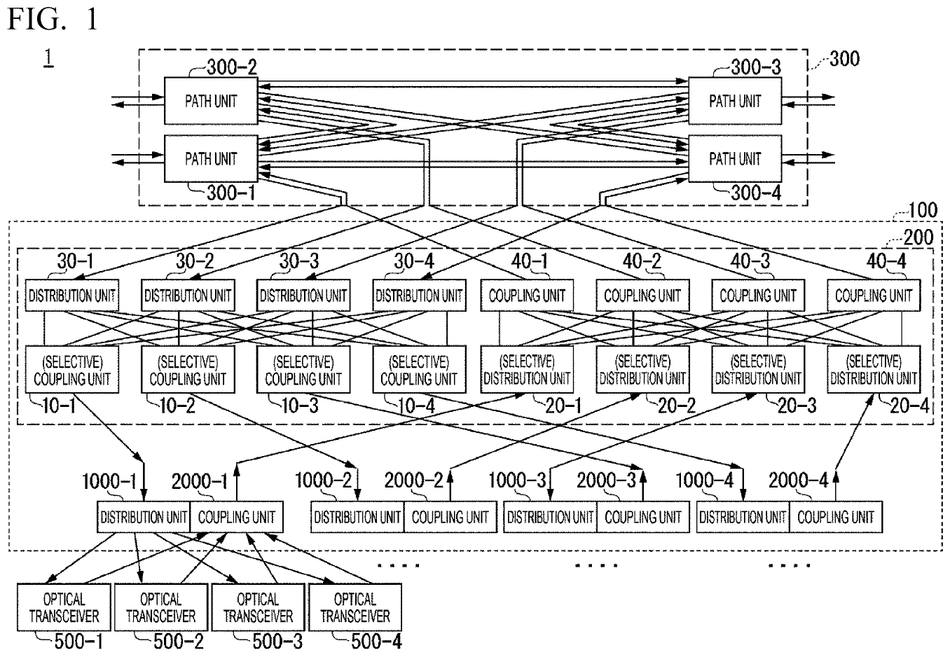

FIG. 1 is a block diagram illustrating a configuration of a communication system 1 including a communication device 100 in a first embodiment. The communication system 1 includes the communication device 100, an optical cross-connect unit 300, and optical transceivers 500-1, 500-2, 500-3, and 500-4. Note that, there are optical transceivers other than the optical transceivers 500-1, 500-2, 500-3, and 500-4, but they are not illustrated in FIG. 1. In a case where the optical transceivers 500-1, 500-2, 500-3, and 500-4 are not distinguished from one another, they are referred to as the optical transceivers 500.

The optical cross-connect unit 300 transmits and receives signals to and from an adjacent network node. The communication device 100 outputs signals input from the optical cross-connect unit 300 to the optical transceivers 500. The communication device 100 outputs signals input from the optical transceivers 500 to the optical cross-connect unit 300.

The communication device 100 includes an optical add/drop unit 200, distribution units 1000-1, 1000-2, 1000-3, and 1000-4, and coupling units 2000-1, 2000-2, 2000-3, and 2000-4. The optical add/drop unit 200 is an example of an optical add/drop apparatus. In a case where the distribution units 1000-1, 1000-2, 1000-3, and 1000-4 are not distinguished from one another, they are referred to as the distribution units 1000. The distribution unit 1000 may be, for example, a distribution unit using a device having no wavelength selectivity such as an optical splitter, or a distribution unit using a device having wavelength selectivity such as a WSS. The distribution unit 1000 is an example of a simultaneous distribution unit. In a case where the coupling units 2000-1, 2000-2, 2000-3, and 2000-4 are not distinguished from one another, they are referred to as the coupling units 2000. The coupling unit 2000 may be a coupling unit using a device having no wavelength selectivity such as an optical coupler, or may be a coupling unit using a device having wavelength selectivity such as the WSS. The coupling unit 2000 is an example of a simultaneous coupling unit.

The optical add/drop unit 200 includes distribution units 30-1, 30-2, 30-3, and 30-4, coupling units 40-1, 40-2, 40-3, and 40-4, (selective) coupling units 10-1, 10-2, 10-3, and 10-4, and (selective) distribution units 20-1, 20-2, 20-3, and 20-4. In a case where the distribution units 30-1, 30-2, 30-3, and 30-4 are not distinguished from one another, they are referred to as the distribution units 30. In a case where the coupling units 40-1, 40-2, 40-3, and 40-4 are not distinguished from one another, they are referred to as the coupling units 40. In a case where the (selective) coupling units 10-1, 10-2, 10-3, and 10-4 are not distinguished from one another, they are referred to as the (selective) coupling units 10. In a case where the (selective) distribution units 20-1, 20-2, 20-3, and 20-4 are not distinguished from one another, they are referred to as the (selective) distribution units 20. The distribution unit 30 is an example of a downlink distribution unit. The (selective) coupling unit 10 is an example of a downlink coupling unit. Note that, the (selective) coupling unit 10 may be a selective coupling unit or may be a simple coupling unit that cannot be selected. The (selective) distribution unit 20 may be a selective distribution unit or may be a simple distribution unit that cannot be selected.

The distribution units 30 are connected to the respective (selective) coupling units 10, and output the signals input from the optical cross-connect unit 300 to the (selective) coupling units 10. The (selective) coupling unit 10 receives the signal from each distribution unit 30. The (selective) coupling unit 10-1 outputs a signal to the distribution unit 1000-1. The (selective) coupling unit 10-2 outputs a signal to the distribution unit 1000-2. The (selective) coupling unit 10-3 outputs a signal to the distribution unit 1000-3. The (selective) coupling unit 10-4 outputs a signal to the distribution unit 1000-4.

The distribution unit 1000-1 is connected to each optical transceiver 500. The distribution unit 1000-1 can simultaneously output a plurality of downlink wavelength signals from a plurality of paths to one or more optical transceivers 500. Note that, the distribution units 1000-2, 1000-3, and 1000-4 are also connected to optical transceivers not illustrated. Specifically, the distribution unit 1000-2 is connected to four optical transceivers. The distribution unit 1000-3 is connected to four optical transceivers. The distribution unit 1000-4 is connected to four optical transceivers. The distribution units 1000-2, 1000-3, and 1000-4 can simultaneously output a plurality of downlink wavelength signals from a plurality of paths to one or more optical transceivers connected thereto.

The coupling unit 2000-1 is connected to each optical transceiver 500 and the (selective) distribution unit 20-1. The coupling unit 2000-1 can simultaneously receive a plurality of uplink wavelength signals paired with the downlink wavelength signals from the optical transceivers 500. Note that, the coupling units 2000-2, 2000-3, and 2000-4 are also connected to optical transceivers not illustrated. Specifically, the coupling unit 2000-2 is connected to four optical transceivers. The coupling unit 2000-3 is connected to four optical transceivers. The coupling unit 2000-4 is connected to four optical transceivers.

The (selective) distribution unit 20 is connected to each coupling unit 40. The (selective) distribution unit 20 outputs a signal input from the coupling unit 2000 to the coupling unit 40. The coupling unit 40 outputs the signal input from the (selective) distribution unit 20 to the optical cross-connect unit 300.

The optical cross-connect unit 300 includes path units 300-1, 300-2, 300-3, and 300-4. In a case where the path units 300-1, 300-2, 300-3, and 300-4 are not distinguished from one another, they are referred to as the path units 300. The path unit 300 can input and output signals to and from not only the adjacent network node and the communication device 100 but also other path units 300 other than the path unit 300 itself. Note that, the number of paths of the optical cross-connect unit is set to four, but this may be less than four or five or more. In a case where there is two or one path unit, this is not referred to as cross-connect in some cases, but this is also referred to as the optical cross-connect unit for convenience in the following description.

The path unit 300-1 is connected to the distribution unit 30-1 and the coupling unit 40-1. The path unit 300-2 is connected to the distribution unit 30-2 and the coupling unit 40-2. The path unit 300-3 is connected to the distribution unit 30-3 and the coupling unit 40-3. The path unit 300-4 is connected to the distribution unit 30-4 and the coupling unit 40-4.

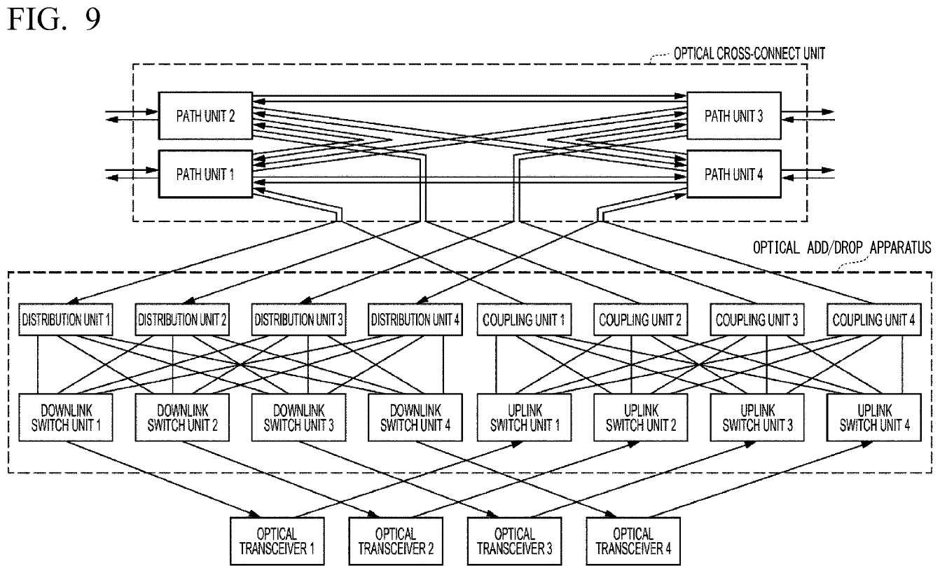

In the conventional technology, as illustrated in FIG. 9, an optical add/drop apparatus and an optical transceiver are directly connected to each other. In contrast, in the present embodiment, by providing the distribution unit 1000 and the coupling unit 2000 between the optical add/drop unit 200 and the optical transceiver 500, the distribution unit 1000 can simultaneously output a plurality of downlink wavelength signals coming from a plurality of paths. The coupling unit 2000 can simultaneously receive a plurality of uplink wavelength signals paired with the downlink wavelength signals from the optical transceivers 500.

According to the present embodiment, in a case where a plurality of optical transceivers 500 is extended to another base, the number of optical fibers connecting the optical add/drop unit 200 and the extension base can be reduced. Furthermore, in a case where a multi-wavelength collective optical transceiver in which a plurality of optical transceivers 500 is integrated is used, the number of optical fibers connecting the optical add/drop unit 200 and the multi-wavelength collective optical transceiver can be reduced.

Here, a setting example in the communication device 100 is described. Setting for the downlink signal is performed as follows, for example. A controller not illustrated that controls the communication system 1 sets the WSS (not illustrated) of the optical cross-connect unit 300 in such a manner that a desired wavelength is output to each distribution unit 30. The controller also sets the (selective) coupling unit 10 to output a signal to a desired port. Similarly, the setting for the uplink signal is performed as follows, for example. As the setting for the uplink signal, the controller sets the WSS (not illustrated) of the optical cross-connect unit 300 in such a manner that the desired wavelength is output to each path. The controller also sets the (selective) distribution unit 20 to output a signal to a desired port.

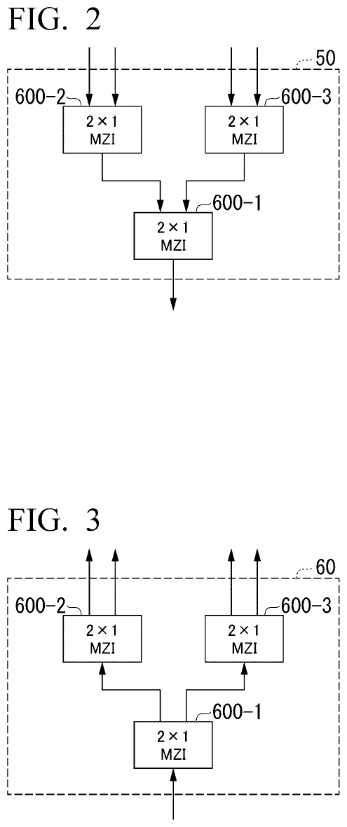

Next, configuration examples of the above-described selective coupling unit and selective distribution unit will be described. FIG. 2 is a diagram illustrating the configuration example of the selective coupling unit 50. FIG. 3 is a diagram illustrating the configuration example of the selective distribution unit 60. In each configuration, 2×1 Mach-Zehnder interferometers (MZIs) are hierarchically connected. In the following description, the “2×1 Mach-Zehnder interferometer” is simply referred to as “MZI”.

As illustrated in FIGS. 2 and 3, the MZI includes two input ports and one output port. In the selective coupling unit 50 illustrated in FIG. 2, the output ports of the MZIs 600-2 and 600-3 are connected to the input ports of the MZI 600-1. In the selective distribution unit 60 illustrated in FIG. 3, one of the output ports of the MZI 600-1 is connected to the input port of the MZI 600-2. The other of the output ports of the MZI 600-1 is connected to the input port of the MZI 600-3.

The MZI can change a power ratio of the signals from the two input ports to couple and output by changing an interference condition. Therefore, by appropriately selecting the interference condition, the power ratio of the signals input to the two input ports can be changed to 1:0, 1:1, and 0:1. Note that, in a case where the power ratio is set to 1:1, a principle loss of 3 dB occurs, but in a case where either 1:0 or 0:1 is selected, no principle loss occurs.

By using this, in the selective coupling unit 50, it is possible to output the signals input to the four input ports of the MZIs 600-2 and 600-3 while setting the power ratio thereof to 1:1:1:1, or optionally select the signals input to the four input ports as 1:0:1:0, couple, and output. In a case of outputting while setting the power ratio to 1:1:1:1, a principle loss of 6 dB occurs, and in a case of 1:0:1:0, a principle loss of 3 dB occurs.

By using the configuration illustrated in FIG. 2, it is possible to reduce a total loss between the input and output by narrowing the selected ports as compared with a case of using a simple 4×1 optical coupler. The selective distribution unit 60 can distribute signals input from one port to any output destinations. The configuration illustrated in FIGS. 2 and 3 can be implemented by a planar optical waveguide. By applying a 2×1 directional coupler capable of changing a coupling length instead of the MZI, an operation similar to the operation in the configuration using the MZI can be performed.

In a spatial optical system, a movable mechanism capable of selectively arranging a beam combiner/splitter and a mirror on an optical path is provided. By using a circuit that changes a ratio of transmitted light to reflected light in the optical path to 1:1 (when beam combiner/splitter is selected), 0:1 (when mirror is selected), or 1:0 (through), an operation similar to the operation in the configuration using the MZI can be performed.

### Second Embodiment

A second embodiment is a mode in which the distribution unit 30 and the coupling unit 40 in the first embodiment are replaced with a splitter and a coupler, respectively. In this case, in a case where a simple coupling unit is used instead of the selective coupling unit, an optical signal from an unnecessary path cannot be blocked, so that another signal having the same wavelength as a desired signal cannot exist in the unnecessary path. Therefore, the second embodiment is a mode in which the (selective) coupling unit 10 in the first embodiment is only a selective coupling unit 50, and the (selective) distribution unit 20 is only a selective distribution unit 60.

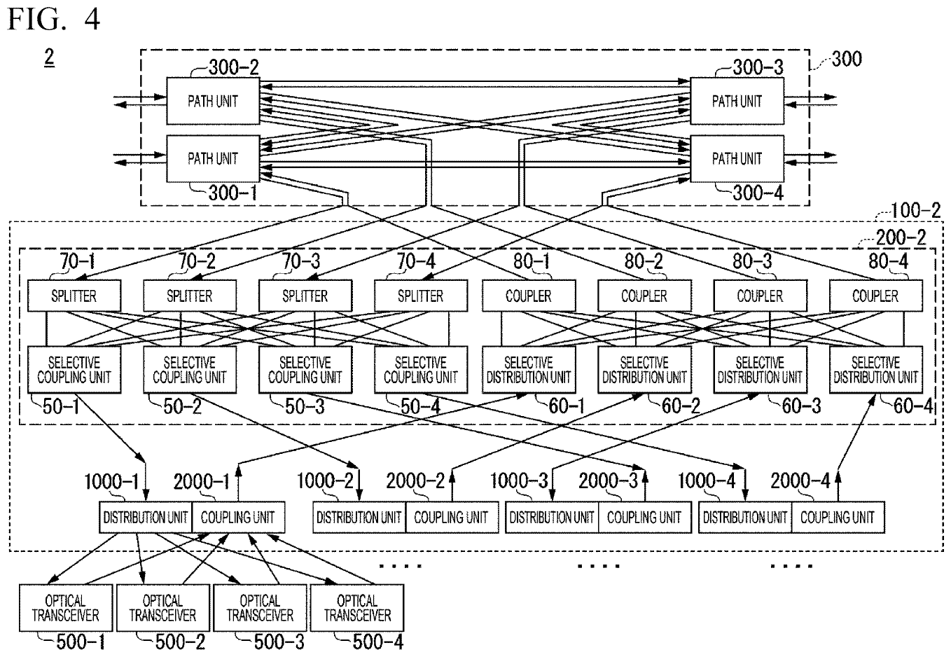

FIG. 4 is a block diagram illustrating a configuration of a communication system 2 including a communication device 100-2 in the second embodiment. The communication system 2 includes the communication device 100-2, an optical cross-connect unit 300, and optical transceivers 500-1, 500-2, 500-3, and 500-4. Note that, there are optical transceivers other than the optical transceivers 500-1, 500-2, 500-3, and 500-4, but they are not illustrated in FIG. 4. In a case where the optical transceivers 500-1, 500-2, 500-3, and 500-4 are not distinguished from one another, they are referred to as the optical transceivers 500.

The optical cross-connect unit 300 transmits and receives signals to and from an adjacent network node. The communication device 100-2 outputs signals input from the optical cross-connect unit 300 to the optical transceivers 500. The communication device 100-2 outputs signals input from the optical transceivers 500 to the optical cross-connect unit 300.

The communication device 100-2 includes an optical add/drop unit 200-2, distribution units 1000-1, 1000-2, 1000-3, and 1000-4, and coupling units 2000-1, 2000-2, 2000-3, and 2000-4. In a case where the distribution units 1000-1, 1000-2, 1000-3, and 1000-4 are not distinguished from one another, they are referred to as the distribution units 1000. The distribution unit 1000 may be, for example, a distribution unit using a device having no wavelength selectivity such as an optical splitter, or a distribution unit using a device having wavelength selectivity such as a WSS. The distribution unit 1000 is an example of a simultaneous distribution unit. In a case where the coupling units 2000-1, 2000-2, 2000-3, and 2000-4 are not distinguished from one another, they are referred to as the coupling units 2000. The coupling unit 2000 may be a coupling unit using a device having no wavelength selectivity such as an optical coupler, or may be a coupling unit using a device having wavelength selectivity such as the WSS. The coupling unit 2000 is an example of a simultaneous coupling unit.

The optical add/drop unit 200-2 includes splitters 70-1, 70-2, 70-3, and 70-4, couplers 80-1, 80-2, 80-3, and 80-4, selective coupling units 50-1, 50-2, 50-3, and 50-4, and selective distribution units 60-1, 60-2, 60-3, and 60-4. In a case where the splitters 70-1, 70-2, 70-3, and 70-4 are not distinguished from one another, they are referred to as the splitters 70. In a case where the couplers 80-1, 80-2, 80-3, and 80-4 are not distinguished from one another, they are referred to as the couplers 80. In a case where the selective coupling units 50-1, 50-2, 50-3, and 50-4 are not distinguished from one another, they are referred to as the selective coupling units 50. In a case where the selective distribution units 60-1, 60-2, 60-3, and 60-4 are not distinguished from one another, they are referred to as the selective distribution units 60. The splitter 70 is an example of a downlink distribution unit. The selective coupling unit 50 is an example of a downlink coupling unit.

The splitters 70 are connected to the respective Selective coupling units 50, and output the signals input from the optical cross-connect unit 300 to the selective coupling units 50. The selective coupling unit 50 receives the signal from each splitter 70. The selective coupling unit 50-1 outputs a signal to the distribution unit 1000-1. The selective coupling unit 50-2 outputs a signal to the distribution unit 1000-2. The selective coupling unit 50-3 outputs a signal to the distribution unit 1000-3. The selective coupling unit 50-4 outputs a signal to the distribution unit 1000-4.

The distribution unit 1000-1 is connected to each optical transceiver 500. The distribution unit 1000-1 can simultaneously output a plurality of downlink wavelength signals from a plurality of paths to one or more optical transceivers 500. Note that, the distribution units 1000-2, 1000-3, and 1000-4 are also connected to optical transceivers not illustrated. Specifically, the distribution unit 1000-2 is connected to four optical transceivers. The distribution unit 1000-3 is connected to four optical transceivers. The distribution unit 1000-4 is connected to four optical transceivers. The distribution units 1000-2, 1000-3, and 1000-4 can simultaneously output a plurality of downlink wavelength signals from a plurality of paths to one or more optical transceivers connected thereto.

The coupling unit 2000-1 is connected to each optical transceiver 500 and the selective distribution unit 60-1. The coupling unit 2000-1 can simultaneously receive a plurality of uplink wavelength signals paired with the downlink wavelength signals from the optical transceivers 500. Note that, the coupling units 2000-2, 2000-3, and 2000-4 are also connected to optical transceivers not illustrated. Specifically, the coupling unit 2000-2 is connected to four optical transceivers. The coupling unit 2000-3 is connected to four optical transceivers. The coupling unit 2000-4 is connected to four optical transceivers.

The selective distribution unit 60 is connected to each coupler 80. The selective distribution unit 60 outputs a signal input from the coupling unit 2000 to the coupler 80. The coupler 80 outputs the signal input from the selective distribution unit 60 to the optical cross-connect unit 300.

The optical cross-connect unit 300 includes path units 300-1, 300-2, 300-3, and 300-4. In a case where the path units 300-1, 300-2, 300-3, and 300-4 are not distinguished from one another, they are referred to as the path units 300. The path unit 300 can input and output signals to and from not only the adjacent network node and the communication device 100-2 but also other path units 300 other than the path unit 300 itself.

The path unit 300-1 is connected to the splitter 70-1 and the coupler 80-1. The path unit 300-2 is connected to the splitter 70-2 and the coupler 80-2. The path unit 300-3 is connected to the splitter 70-3 and the coupler 80-3. The path unit 300-4 is connected to the splitter 70-4 and the coupler 80-4.

In the conventional technology, as illustrated in FIG. 9, an optical add/drop apparatus and an optical transceiver are directly connected to each other. In contrast, in the present embodiment, by providing the distribution unit 1000 and the coupling unit 2000 between the optical add/drop unit 200 and the optical transceiver 500, the distribution unit 1000 can simultaneously output a plurality of downlink wavelength signals coming from a plurality of paths. The coupling unit 2000 can simultaneously receive a plurality of uplink wavelength signals paired with the downlink wavelength signals from the optical transceivers 500.

According to the present embodiment, in a case where a plurality of optical transceivers 500 is extended to another base, the number of optical fibers connecting the optical add/drop unit 200-2 and the extension base can be reduced. Furthermore, in a case where a multi-wavelength collective optical transceiver in which a plurality of optical transceivers 500 is integrated is used, the number of optical fibers connecting the optical add/drop unit 200-2 and the multi-wavelength collective optical transceiver can be reduced.

### Third Embodiment

A third embodiment is a mode in which the splitter 70 and the coupler 80 in the second embodiment are replaced with a selective distribution unit and a selective coupling unit, respectively. In this case, the selective distribution unit replacing the splitter selectively outputs a plurality of downlink signals having different wavelengths input to the selective distribution unit to a necessary output port, and does not select other ports as output destinations. The selective coupling unit replacing the coupler selectively inputs a plurality of uplink signals having different wavelengths that should be input to the selective coupling unit from the necessary input port, and does not select other inputs. With such a configuration, a loss between an input and an output of the optical add/drop unit can be further reduced.

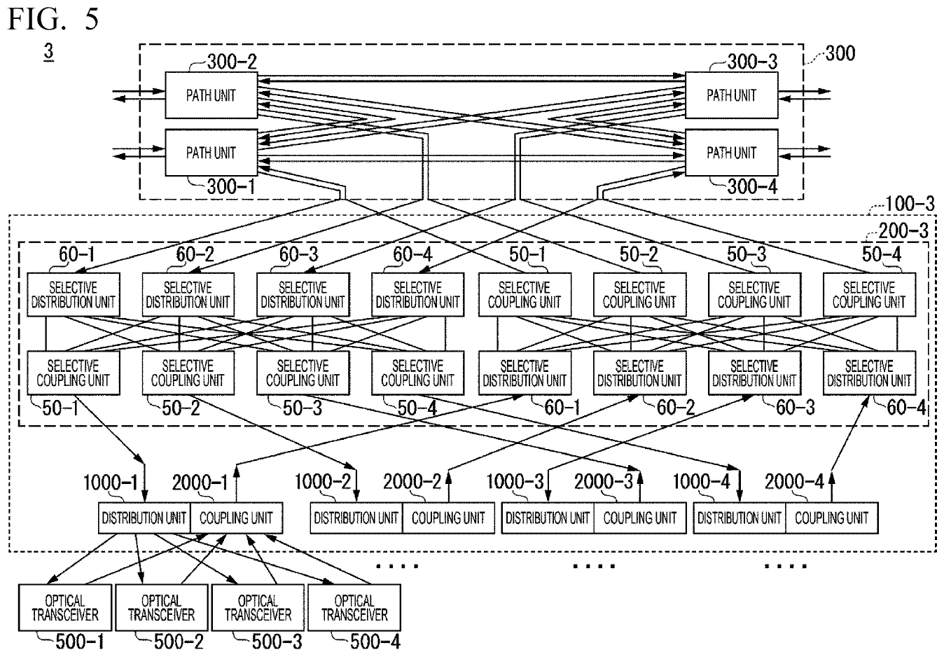

FIG. 5 is a block diagram illustrating a configuration of a communication system 2 including a communication device 100-3 in the third embodiment. The communication system 2 includes the communication device 100-3, an optical cross-connect unit 300, and optical transceivers 500-1, 500-2, 500-3, and 500-4. Note that, there are optical transceivers other than the optical transceivers 500-1, 500-2, 500-3, and 500-4, but they are not illustrated in FIG. 5. In a case where the optical transceivers 500-1, 500-2, 500-3, and 500-4 are not distinguished from one another, they are referred to as the optical transceivers 500.

The optical cross-connect unit 300 transmits and receives signals to and from an adjacent network node. The communication device 100-3 outputs signals input from the optical cross-connect unit 300 to the optical transceiver 500. The communication device 100-3 outputs signals input from the optical transceivers 500 to the optical cross-connect unit 300.

The communication device 100-3 includes an optical add/drop unit 200-3, distribution units 1000-1, 1000-2, 1000-3, and 1000-4, and coupling units 2000-1, 2000-2, 2000-3, and 2000-4. In a case where the distribution units 1000-1, 1000-2, 1000-3, and 1000-4 are not distinguished from one another, they are referred to as the distribution units 1000. The distribution unit 1000 may be, for example, a distribution unit using a device having no wavelength selectivity such as an optical splitter, or a distribution unit using a device having wavelength Selectivity such as a WSS. The distribution unit 1000 is an example of a simultaneous distribution unit. In a case where the coupling units 2000-1, 2000-2, 2000-3, and 2000-4 are not distinguished from one another, they are referred to as the coupling units 2000. The coupling unit 2000 may be a coupling unit using a device having no wavelength selectivity such as an optical coupler, or may be a coupling unit using a device having wavelength selectivity such as the WSS. The coupling unit 2000 is an example of a simultaneous coupling unit.

The optical add/drop unit 200-3 includes selective distribution units 60-1, 60-2, 60-3, and 60-4, selective coupling units 50-1, 50-2, 50-3, and 50-4, selective coupling units 50-1, 50-2, 50-3, and 50-4, and selective distribution units 60-1, 60-2, 60-3, and 60-4. In a case where the selective distribution units 60-1, 60-2, 60-3, and 60-4 are not distinguished from one another, they are referred to as the selective distribution units 60. In a case where the selective coupling units 50-1, 50-2, 50-3, and 50-4 are not distinguished from one another, they are referred to as the selective coupling units 50. In a case where the selective coupling units 50-1, 50-2, 50-3, and 50-4 are not distinguished from one another, they are referred to as the selective coupling units 50. In a case where the selective distribution units 60-1, 60-2, 60-3, and 60-4 are not distinguished from one another, they are referred to as the selective distribution units 60. The selective distribution unit 60 is an example of a downlink distribution unit. The selective coupling unit 50 is an example of a downlink coupling unit.

The selective distribution units 60 are connected to the respective selective coupling units 50, and output the signals input from the optical cross-connect unit 300 to the selective coupling units 50. The selective coupling unit 50 receives the signal from each selective distribution unit 60. The selective coupling unit 50-1 outputs a signal to the distribution unit 1000-1. The selective coupling unit 50-2 outputs a signal to the distribution unit 1000-2. The selective coupling unit 50-3 outputs a signal to the distribution unit 1000-3. The selective coupling unit 50-4 outputs a signal to the distribution unit 1000-4.

The distribution unit 1000-1 is connected to each optical transceiver 500. The distribution unit 1000-1 can simultaneously output a plurality of downlink wavelength signals from a plurality of paths to one or more optical transceivers 500. Note that, the distribution units 1000-2, 1000-3, and 1000-4 are also connected to optical transceivers not illustrated. Specifically, the distribution unit 1000-2 is connected to four optical transceivers. The distribution unit 1000-3 is connected to four optical transceivers. The distribution unit 1000-4 is connected to four optical transceivers. The distribution units 1000-2, 1000-3, and 1000-4 can simultaneously output a plurality of downlink wavelength signals from a plurality of paths to one or more optical transceivers connected thereto.

The coupling unit 2000-1 is connected to each optical transceiver 500 and the selective distribution unit 60-1. The coupling unit 2000-1 can simultaneously receive a plurality of uplink wavelength signals paired with the downlink wavelength signals from the optical transceivers 500. Note that, the coupling units 2000-2, 2000-3, and 2000-4 are also connected to optical transceivers not illustrated. Specifically, the coupling unit 2000-2 is connected to four optical transceivers. The coupling unit 2000-3 is connected to four optical transceivers. The coupling unit 2000-4 is connected to four optical transceivers.

The selective distribution unit 60 is connected to each selective coupling unit 50. The selective distribution unit 60 outputs a signal input from the coupling unit 2000 to the selective coupling unit 50. The selective coupling unit 50 outputs the signal input from the selective distribution unit 60 to the optical cross-connect unit 300.

The optical cross-connect unit 300 includes path units 300-1, 300-2, 300-3, and 300-4. In a case where the path units 300-1, 300-2, 300-3, and 300-4 are not distinguished from one another, they are referred to as the path units 300. The path unit 300 can input and output signals to and from not only the adjacent network node and the communication device 100-3 but also other path units 300 other than the path unit 300 itself.

The path unit 300-1 is connected to the selective distribution unit 60-1 and the selective coupling unit 50-1. The path unit 300-2 is connected to the selective distribution unit 60-2 and the selective coupling unit 50-2. The path unit 300-3 is connected to the selective distribution unit 60-3 and the selective coupling unit 50-3. The path unit 300-4 is connected to the selective distribution unit 60-4 and the selective coupling unit 50-4.

In the conventional technology, as illustrated in FIG. 9, an optical add/drop apparatus and an optical transceiver are directly connected to each other. In contrast, in the present embodiment, by providing the distribution unit 1000 and the coupling unit 2000 between the optical add/drop unit 200 and the optical transceiver 500, the distribution unit 1000 can simultaneously output a plurality of downlink wavelength signals coming from a plurality of paths. The coupling unit 2000 can simultaneously receive a plurality of uplink wavelength signals paired with the downlink wavelength signals from the optical transceivers 500.

According to the present embodiment, in a case where a plurality of optical transceivers 500 is extended to another base, the number of optical fibers connecting the optical add/drop unit 200-3 and the extension base can be reduced. Furthermore, in a case where a multi-wavelength collective optical transceiver in which a plurality of optical transceivers 500 is integrated is used, the number of optical fibers connecting the optical add/drop unit 200-3 and the multi-wavelength collective optical transceiver can be reduced.

### Application Example of Second Embodiment and Third Embodiment

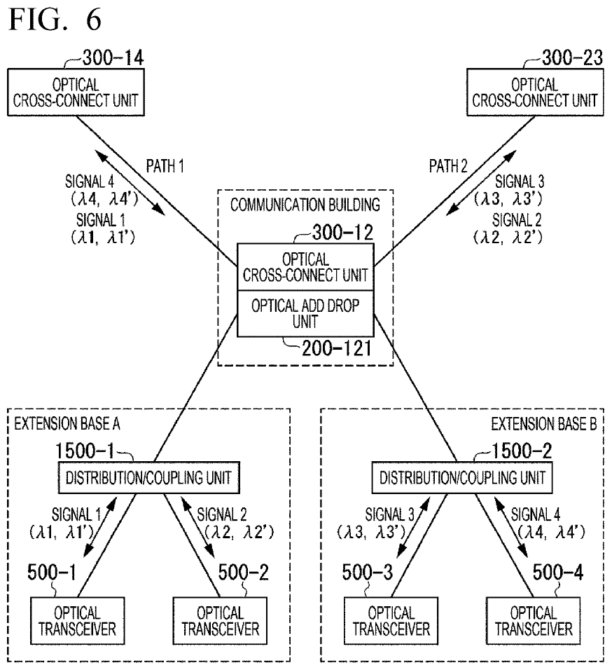

FIG. 6 is a diagram illustrating an application example of the optical add/drop unit 200-2 according to the second embodiment and the optical add/drop unit 200-3 according to the third embodiment. In FIG. 6, an optical add/drop unit 200-121 is the optical add/drop unit 200-2 or the optical add/drop unit 200-3.

In an embodiment illustrated in FIG. 6, an optical cross-connect unit 300-12 and the optical add/drop unit 200-121 are installed in a communication building. The optical cross-connect unit 300-12 is connected to an optical cross-connect unit 300-14 by a path 1, and is connected to an optical cross-connect unit 300-23 by a path 2. The optical add/drop unit 200-121 is connected to a distribution/coupling unit 1500-1 of an extension base A. The optical add/drop unit 200-121 is connected to a distribution/coupling unit 1500-2 of an extension base B. Here, the distribution/coupling units 1500-1 and 1500-2 collectively describe the distribution unit 1000 and the coupling unit 2000. The distribution/coupling unit 1500-1 is connected to the optical transceivers 500-1 and 500-2. The distribution/coupling unit 1500-2 is connected to the optical transceivers 500-3 and 500-4.

In a wavelength multiplexing network, as illustrated in FIG. 6, the optical add/drop unit 200-121 can connect to the extension bases A and B in which a plurality of optical transceivers 500 is arranged by a pair of (uplink and downlink) optical fibers. In FIG. 6, since signals 1 and 2 share an optical fiber between the extension base A and the communication building, different wavelengths (λ1 and λ2) are allocated. Since signals 3 and 4 share an optical fiber between the extension base B and the communication building, different wavelengths (λ3 and λ4) are allocated. In FIG. 6, λ1′ and λ1 represent wavelengths in an uplink direction and a downlink direction forming a pair. λ2′ and λ2 represent wavelengths in an uplink direction and a downlink direction forming a pair. λ3′ and λ3 represent wavelengths in an uplink direction and a downlink direction forming a pair. λ4′ and λ4 represent wavelengths in an uplink direction and a downlink direction forming a pair.

The signals 1 and 2 are multiplexed by the optical add/drop unit 200-121 and transmitted to the extension base A (downlink direction). At that time, the signal 3 coming from the same path 2 as the signal 2 is dropped toward the extension base B via the optical add/drop unit 200-121, and the signals 3 and 4 and need to be set to different wavelengths from the signals 1 and 2.

### Fourth Embodiment

A fourth embodiment is a mode in which the distribution unit 30 and the coupling unit 40 in the first embodiment are replaced with a WSS. In this case, even in a case where a simple coupling unit (for example, a coupler) is used as a (selective) coupling unit 10 and a simple distribution unit (for example, a splitter) is used as a (selective) distribution unit 20, it is possible to block an unnecessary wavelength by the WSS. In contrast, by using a selective coupling unit or a selective distribution unit, an input/output loss can be reduced as compared with a case of using the simple coupling unit (coupler) or the simple distribution unit (splitter).

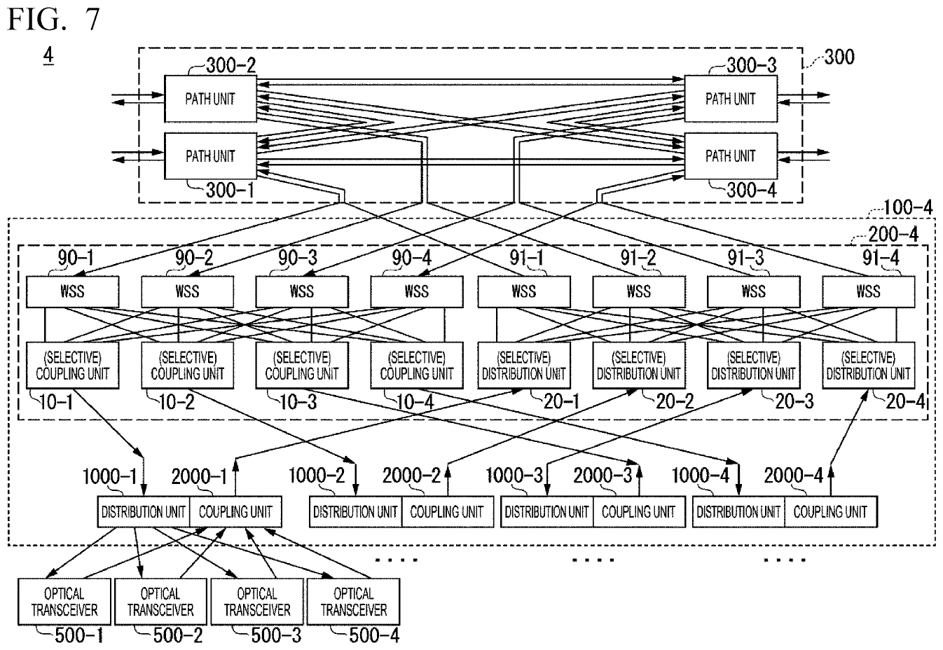

FIG. 7 is a block diagram illustrating a configuration of a communication system 1 including a communication device 100-4 in the fourth embodiment. The communication system 1 includes the communication device 100-4, an optical cross-connect unit 300, and optical transceivers 500-1, 500-2, 500-3, and 500-4. Note that, there are optical transceivers other than the optical transceivers 500-1, 500-2, 500-3, and 500-4, but they are not illustrated in FIG. 7. In a case where the optical transceivers 500-1, 500-2, 500-3, and 500-4 are not distinguished from one another, they are referred to as the optical transceivers 500.

The optical cross-connect unit 300 transmits and receives signals to and from an adjacent network node. The communication device 100-4 outputs signals input from the optical cross-connect unit 300 to the optical transceivers 500. The communication device 100-4 outputs signals input from the optical transceivers 500 to the optical cross-connect unit 300.

The communication device 100-4 includes an optical add/drop unit 200-4, distribution units 1000-1, 1000-2, 1000-3, and 1000-4, and coupling units 2000-1, 2000-2, 2000-3, and 2000-4. In a case where the distribution units 1000-1, 1000-2, 1000-3, and 1000-4 are not distinguished from one another, they are referred to as the distribution units 1000. In a case where the coupling units 2000-1, 2000-2, 2000-3, and 2000-4 are not distinguished from one another, they are referred to as the coupling units 2000. The distribution unit 1000 is an example of a simultaneous distribution unit. The coupling unit 2000 is an example of a simultaneous coupling unit.

The optical add/drop unit 200-4 includes WSSs 90-1, 90-2, 90-3, and 90-4, WSSs 91-1, 91-2, 91-3, and 91-4, (selective) coupling units 10-1, 10-2, 10-3, and 10-4, and (selective) distribution units 20-1, 20-2, 20-3, and 20-4. In a case where the WSSs 90-1, 90-2, 90-3, and 90-4 are not distinguished from one another, they are referred to as the WSSs 90. In a case where the WSSs 91-1, 91-2, 91-3, and 91-4 are not distinguished from one another, they are referred to as the WSSs 91. In a case where the (selective) coupling units 10-1, 10-2, 10-3, and 10-4 are not distinguished from one another, they are referred to as the (selective) coupling units 10. In a case where the (selective) distribution units 20-1, 20-2, 20-3, and 20-4 are not distinguished from one another, they are referred to as the (selective) distribution units 20. The WSS 90 is an example of a downlink distribution unit. The (selective) coupling unit 10 is an example of a downlink coupling unit. Note that, the (selective) coupling unit 10 may be a selective coupling unit or may be a simple coupling unit that cannot be selected. The (selective) distribution unit 20 may be a selective distribution unit or may be a simple distribution unit that cannot be selected.

The WSSs 90 are connected to the respective (selective) coupling units 10, and output the signals input from the optical cross-connect unit 300 to the (selective) coupling units 10. The (selective) coupling unit 10 receives the signal from each WSS 90. The (selective) coupling unit 10-1 outputs a signal to the distribution unit 1000-1. The (selective) coupling unit 10-2 outputs a signal to the distribution unit 1000-2. The (selective) coupling unit 10-3 outputs a signal to the distribution unit 1000-3. The (selective) coupling unit 10-4 outputs a signal to the distribution unit 1000-4.

The distribution unit 1000-1 is connected to each optical transceiver 500. The distribution unit 1000-1 can simultaneously output a plurality of downlink wavelength signals from a plurality of paths to one or more optical transceivers 500. Note that, the distribution units 1000-2, 1000-3, and 1000-4 are also connected to optical transceivers not illustrated. Specifically, the distribution unit 1000-2 is connected to four optical transceivers. The distribution unit 1000-3 is connected to four optical transceivers. The distribution unit 1000-4 is connected to four optical transceivers. The distribution units 1000-2, 1000-3, and 1000-4 can simultaneously output a plurality of downlink wavelength signals from a plurality of paths to one or more optical transceivers connected thereto.

The coupling unit 2000-1 is connected to each optical transceiver 500 and the (selective) distribution unit 20-1. The coupling unit 2000-1 can simultaneously receive a plurality of uplink wavelength signals paired with the downlink wavelength signals from the optical transceivers 500. Note that, the coupling units 2000-2, 2000-3, and 2000-4 are also connected to optical transceivers not illustrated. Specifically, the coupling unit 2000-2 is connected to four optical transceivers. The coupling unit 2000-3 is connected to four optical transceivers. £ The coupling unit 2000-4 is connected to four optical transceivers.

The (selective) distribution unit 20 is connected to each WSS 91. The (selective) distribution unit 20 outputs a signal input from the coupling unit 2000 to the WSS 91. The WSS 91 outputs the signal input from the (selective) distribution unit 20 to the optical cross-connect unit 300.

The optical cross-connect unit 300 includes path units 300-1, 300-2, 300-3, and 300-4. In a case where the path units 300-1, 300-2, 300-3, and 300-4 are not distinguished from one another, they are referred to as the path units 300. The path unit 300 can input and output signals to and from not only the adjacent network node and the communication device 100-4 but also other path units 300 other than the path unit 300 itself.

The path unit 300-1 is connected to the WSS 90-1 and the WSS 91-1. The path unit 300-2 is connected to the WSS 90-2 and the WSS 91-2. The path unit 300-3 is connected to the WSS 90-3 and the WSS 91-3. The path unit 300-4 is connected to the WSS 90-4 and the WSS 91-4.

In the conventional technology, as illustrated in FIG. 9, an optical add/drop apparatus and an optical transceiver are directly connected to each other. In contrast, in the present embodiment, by providing the distribution unit 1000 and the coupling unit 2000 between the optical add/drop unit 200 and the optical transceiver 500, the distribution unit 1000 can simultaneously output a plurality of downlink wavelength signals coming from a plurality of paths. The coupling unit 2000 can simultaneously receive a plurality of uplink wavelength signals paired with the downlink wavelength signals from the optical transceivers 500.

According to the present embodiment, in a case where a plurality of optical transceivers 500 is extended to another base, the number of optical fibers connecting the optical add/drop unit 200-4 and the extension base can be reduced. Furthermore, in a case where a multi-wavelength collective optical transceiver in which a plurality of optical transceivers 500 is integrated is used, the number of optical fibers connecting the optical add/drop unit 200-4 and the multi-wavelength collective optical transceiver can be reduced.

### Application Example of Fourth Embodiment

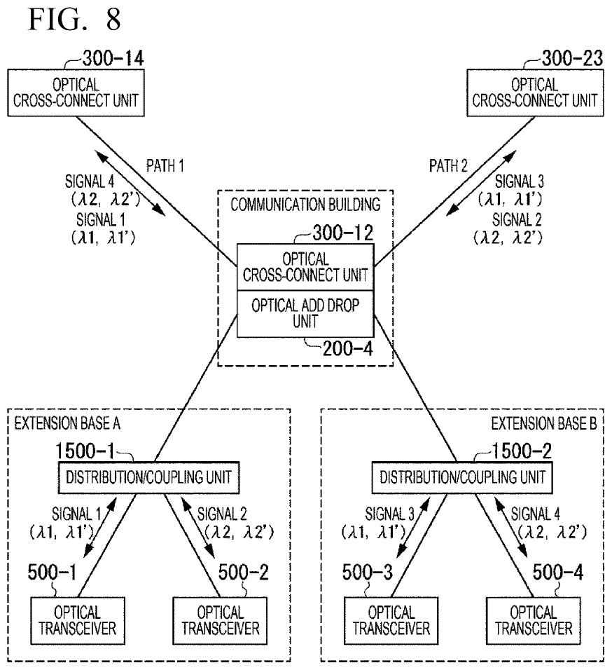

FIG. 8 illustrates an application example of the optical add/drop unit 200-4 in the fourth embodiment. In an embodiment illustrated in FIG. 8, an optical cross-connect unit 300-12 and the optical add/drop unit 200-4 are installed in a communication building.

The optical cross-connect unit 300-12 is connected to an optical cross-connect unit 300-14 by a path 1, and is connected to an optical cross-connect unit 300-23 by a path 2. The optical add/drop unit 200-4 is connected to a distribution/coupling unit 1500-1 of an extension base A.

The optical add/drop unit 200-4 is connected to a distribution/coupling unit 1500-2 of an extension base B.

Here, the distribution/coupling units 1500-1 and 1500-2 collectively describe the distribution unit 1000 and the coupling unit 2000. The distribution/coupling unit 1500-1 is connected to the optical transceivers 500-1 and 500-2.

The distribution/coupling unit 1500-2 is connected to the optical transceivers 500-3 and 500-4.

In this configuration, it is possible to select only a necessary wavelength and pass the same to each selective distribution unit by the WSS, so that, in the wavelength multiplexing network using the same, a restriction on overlapping of wavelengths is further alleviated.

Specifically, in FIG. 8, the same wavelength (λ1, λ1′) can be allocated to the uplink signal and the downlink signal of the signals 1 and 3. The same wavelength (λ2, λ2′) can be allocated to the uplink signal and the downlink signal of the signals 2 and 4. In FIG. 8, λ1′ and λ1 represent wavelengths in an uplink direction and a downlink direction forming a pair. λ2′ and λ2 represent wavelengths in an uplink direction and a downlink direction forming a pair.

As described above, according to the present embodiment, it is possible to simultaneously output a plurality of downlink wavelength signals coming from a plurality of paths of the optical cross-connect unit.

According to the present embodiment, in a case where a plurality of optical transceivers is extended to another base, the number of optical fibers connecting the optical add/drop unit and the extension base can be reduced.

Furthermore, in a case where a multi-wavelength collective optical transceiver in which a plurality of optical transceivers is integrated is used, the number of optical fibers connecting the optical add/drop unit and the multi-wavelength collective optical transceiver can be reduced.

Although the embodiments of the present invention have been described in detail with reference to the drawings, specific configurations are not limited to the embodiments and include design and the like within the gist of the present invention.

### INDUSTRIAL APPLICABILITY

The present invention is applicable to an optical network, an optical communication system, and an optical communication device using a WDM.

### REFERENCE SIGNS LIST

1 Communication system
100 Communication device
200 Optical add/drop unit
1000 Distribution unit
2000 Coupling unit

1. A communication device comprising:
downlink distributors that receive signals from one or more paths, the downlink distributors being provided as many as the number of the paths;
couplers that receive signals from the respective downlink distributors and output signals to optical signal transceivers, the downlink couplers being provided as many as the maximum number of the optical signal transceivers; and
a simultaneous distributors that is provided between the downlink couplers and the optical signal transceivers and is capable of simultaneously outputting signals having wavelengths input from a plurality of paths input from the downlink couplers to the plurality of optical signal transceivers.

2. The communication device according to claim 1, comprising:
uplink couplers that output signals to one or more paths, the uplink couplers being provided as many as the paths;
uplink distributors that output signals to the respective uplink couplers, the uplink distributors being provided as many as the maximum number of the optical signal transceivers; and
a simultaneous couplers that receives signals from the plurality of optical signal transceivers and is capable of simultaneously outputting the input signals to the uplink distributors.

3. The communication device according to claim 2, wherein the downlink couplers or the uplink distributors are Mach-Zehnder interferometers that are hierarchically connected.

4. The communication device according to claim 2, wherein
the downlink distributors are splitters, the uplink couplers are couplers, and the downlink couplers and the uplink distributors are capable of selecting output destinations of signals.

5. The communication device according to claim 2, wherein
the downlink distributors, the downlink couplers, the uplink distributors, and the uplink couplers are capable of selecting output destinations of signals.

6. The communication device according to claim 2, wherein the downlink distributors and the uplink couplers are wavelength selective switches (WSSs).

7. (canceled)

8. An optical add/drop apparatus comprising:
downlink distributors that receive signals from one or more paths, the downlink distributors being provided as many as the paths; and
downlink couplers that receive signals from the respective downlink distributors and output signals to optical signal transceivers, the downlink couplers being provided as many as the maximum number of the optical signal transceivers, wherein
the downlink couplers are capable of optionally selecting signals input from a plurality of ports, coupling, and outputting.

9. An optical add/drop apparatus comprising:
uplink couplers that output signals to one or more paths, the uplink couplers being provided as many as the paths; and
uplink distributors that output signals to the respective uplink couplers, the uplink distributors being provided as many as the maximum number of the optical signal transceivers, wherein
the uplink distributors are capable of distributing signals input from one port to any output destinations.

10. (canceled)

11.(canceled)
